(19) United States
(12) Patent Application Publication
(10) Pub. No.: US 2006/0024029 A1
(43) Pub. Date: Feb. 2, 2006

(54) Program output control apparatus and method

(76) Inventors: Tomochika Yamashita, Yokohama (JP); Yumi Shibutani, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/193,496

(22) Filed: Aug. 1, 2005

(30) Foreign Application Priority Data
Aug. 2, 2004 (JP) 2004-225325

(51) Int. Cl. H04N 5/445; H04N 5/76

(52) U.S. Cl. 386/83; 725/58

(57) ABSTRACT

A program output control apparatus includes a storage area of program information which stores program information, and an output controller which controls an output of the user-desired program corresponding to the user desired channel and display operation of the program information. The program information includes two or more pieces of program data corresponding to two or more broadcasting programs. Each of the pieces of program data includes attributions on the broadcasting time zone of the broadcasting program corresponding to the program data and on the broadcasting program. The output controller obtains program data on a time zone after the current broadcasting time zone of the user desired channel, or program data at or after the current broadcasting time zone of another channel, and executes the display operation of the obtained program data together with the output of the user-desired program.

The present application claims priority from Japanese application serial no. JP 2004-225325, filed on Aug. 2, 2004, the content of which is hereby incorporated by reference into this application.

### BACKGROUND OF THE INVENTION

1. Field of the Invention

The present invention relates to a technology for controlling an output of a broadcasting program or broadcasting program information, and more particularly, to a technology for controlling the display operation of broadcasting program information.

2. Description of the Related Art

As broadcasting program information, a so-called EPG (Electric Program Guide) is well-known. Further, Japanese Laid-Open Patent Publication No. Hei 11-298863 discloses a receiving apparatus as a well-known control apparatus for the display operation of broadcasting program information. The receiving apparatus displays plural program information elements on the current time zone corresponding to plural channels, and scroll-displays the program information element selected by a user.

### SUMMARY OF THE INVENTION

With the above-mentioned receiving apparatus, the user knows program contents on the current time zone while viewing a program video image on the current time zone. However, the user does not know which program is scheduled on which time zone, after the current time zone. The above-mentioned problem exists in various broadcastings including a terrestrial digital broadcasting, a terrestrial analog broadcasting, a satellite broadcasting, and a teletext broadcasting.

Accordingly, it is an object of the present invention to provide a technology, by which the user knows a broadcasting schedule from now on or broadcasting program contents of a current time zone of another channel while receiving an output of a broadcasting program on a desired channel in progress of broadcasting.

In order to solve the above-mentioned problem of the present invention, according to a first aspect of the present invention, a program output control apparatus includes:
a storage area of program information that stores program information; and
output controller that controls an output of a user-desired program corresponding to a broadcasting channel selected by a user and display operation of the program information from among plural programs being broadcasted corresponding to plural broadcasting channels,
wherein the program information includes two or more pieces of program data corresponding to two or more broadcasting programs, and the two or more pieces of program data include a broadcasting time zone of the broadcasting program corresponding to the program data and broadcasting program attribution indicating an attribution of the broadcasting program, and
the output controller executes at least one of:
   (1) processing for obtaining, from the storage area of program information, the program data on the broadcasting channel selected by the user from among the plural broadcasting channels and on a time zone after the current time zone of the broadcasting channel; and
   (2) processing for obtaining, from the storage area of program information, the program data on another broadcasting channel of the broadcasting channel selected by the user from among the plural broadcasting channels, and on at least one time zone at or after the current broadcasting time zone of the other broadcasting channel, and
further executes display operation of the obtained program data together with the output of the user-desired program.

The program output control apparatus is communicable with a storage device that stores the broadcasting program, and the output controller executes processing for receiving a recording command of the broadcasting program, specifying, in response to the recording command, the program data in progress of display operation from the two or more pieces of program data and for automatically processing for recording, to the storage device, the broadcasting program corresponding to the program data by using a broadcasting time zone and an attribution of the broadcasting program included in the specified program data, when the time and data are the broadcasting time zone (the start time and date, for example).

When the program data in progress of display operation is program data at the after-time zone (hereinafter, referred to as data on after-time zone), the recording command becomes a recording reservation command, and the processing executed by the output controller may be recording reservation processing. Here, the “recording reservation processing” sets, into a predetermined storage area, the recording reservation data including the start time and date of the broadcasting time zone and the broadcasting program attribution (e.g., broadcasting channel identifier) by using the broadcasting time zone and broadcasting program attribution included in the specified program data on after-time zone. Thus, the recording reservation data set to the predetermined storage area is read out to a recording executing unit included in the program output control apparatus and the storage device, the time and date are the start time and date, and then the recording executing unit automatically starts processing for recording, to the storage device, the broadcasting program corresponding to the specified program data on the after-time time zone. Incidentally, the “predetermined storage area” is provided for a storage medium, such as a memory, and may be arranged in the program output control apparatus or storage device. Further, the “storage device” may be arranged to the program output control apparatus.

The program output control apparatus further includes a storage area of display condition that display condition stores data, to which a time range starting from a time point in the current time zone, is set as a display condition, and the output controller specifies the program data corresponding to an after-time zone within the time range from the storage area of program information based on the time range set to the display condition data and the broadcasting time zone included in each of the two or more pieces of program data, and displays the specified program data. Incidentally, when the output controller ends to display all pieces of specified data, the output controller may restart to display the specified program data (that is, may repeat the display operation).

In the program output control apparatus, the broadcasting program is a television broadcasting program including a program video image, the program output control apparatus further includes a display screen, and the output controller displays, on the display screen, the program video image of the user-desired program, overlays and displays a program guide area to the program video image at an end of the display screen or near it, and displays the obtained program data in the program guide display area.

In the program output control apparatus, the output controller selectively switches between a first display system for fixing display operation of the program data in the program guide display area to the program guide display area and a second display system for scroll-displaying the program data in the program guide display area, in accordance with whether or not the display operation of the obtained program data is included in the program guide display area.

According to a second aspect of the present invention, a program output control method includes:
a step of outputting a user-desired program corresponding to a broadcasting channel selected by a user from among plural programs being broadcasted corresponding to plural broadcasting channels;
a step of executing at least one of
   (1) processing for obtaining, from a storage area of program information, program data on the broadcasting channel selected by the user from among the plural broadcasting channels and on a time zone after the current time zone of the broadcasting channel, of two or more pieces of program data including broadcasting time zones and broadcasting program attributions of two or more broadcasting programs, and
   (2) processing for obtaining, from among the two or more pieces of program data, the program data on another broadcasting channel of the broadcasting channel selected by the user from among the plural broadcasting channels and on at least one time zone at or after the current broadcasting time zone of the other broadcasting channel; and
a step of executing display operation of the obtained program data together with an output of the user-desired program.

According to the present invention, a user knows broadcasting schedule from now on or broadcasting program contents of a current time zone of another channel, while receiving an output of a broadcasting program on a desired channel in progress of broadcasting.

### BRIEF DESCRIPTION OF THE DRAWINGS

FIG. 1 is a block diagram showing an example of the structure of a television apparatus having a program output control apparatus according to an embodiment of the present invention;

FIG. 2 is a flowchart of processing by a display control unit;

FIGS. 3A to 3D are explanatory diagrams of scroll display operation of a program information element on an after-time zone;

FIGS. 4A to 4C are explanatory diagrams of intermittent switching display operation of the program information element on the after-time zone;

FIGS. 5A to 5D are explanatory diagrams of the display operation of the program information element on the after-time zones of plural channels;

FIGS. 6A to 6C are explanatory diagrams of varied examples of a display position of the program information element;

FIG. 7A is a diagram showing an example of a display screen upon preferentially displaying a broadcasting program video image rather than the program information element;

FIG. 7B is a diagram showing an example of a display screen upon preferentially displaying the program information element rather than the broadcasting program video image;

FIG. 8 is a diagram showing an example of the program information element upon arranging plural display secondary screens onto a display screen according to the embodiment; and

FIG. 9 is a flowchart showing an example of recording reservation processing of the display control unit according to a modification of the embodiment of the present invention.

### DETAILED DESCRIPTION OF THE PREFERRED EMBODIMENT

According to the present invention, a program output control apparatus is used for various broadcastings, such as a television broadcasting or radio broadcasting. Further, the program output control apparatus is used for various receiving devices, such as a television apparatus, radio apparatus, and a recording and play apparatus. Hereinafter, a description is a television apparatus using a program output control apparatus according to an embodiment of the present invention.

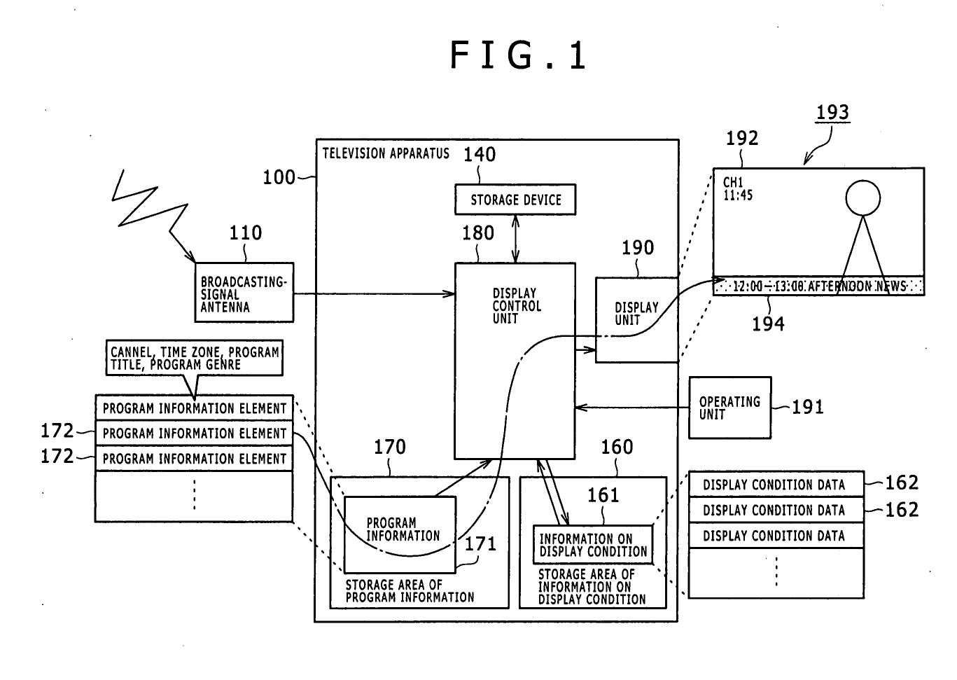

FIG. 1 is a block diagram showing an example of the structure of a television apparatus using the program output control apparatus according to the embodiment of the present invention.

For example, a digital broadcasting signal (e.g., transport stream data in MPEG2 format is received by a television apparatus 100 via a broadcasting-signal antenna 110. The television apparatus 100 includes: a storage device 140; a display unit 190; an operating unit 191; a storage area 170 of program information; a storage area 160 of information on the display condition; and a display control unit 180.

The storage device 140 stores data on digital contents (e.g., data in the MPEG2 format), such as a hard disk drive, a hard disk recorder, a DVD (Digital Versatile Disk) drive, or a DVD recorder. As long as the storage device 140 is communicable with the television apparatus 100, the storage device 140 may be externally arranged to the television apparatus 100. In other words, the storage device 140 may be included in the television apparatus 100 or be externally arranged thereto.

The display unit 190 includes, e.g., a CRT, liquid crystal, or plasma display screen.

The operating unit 191 is a controller for operating the television apparatus 100. The operating unit 191 includes plural buttons for inputting a user desired channel from among plural channels and a display condition to be included in information 161 on the display condition, and sends a signal based on a pressed button to the television apparatus 100.

The storage area 170 of program information is arranged on a storage medium (e.g., a memory). The storage area 170 of program information stores program information 171. The program information 171 is information on the broadcasting program, e.g., EPG (Electric Program Guide). The program information 171 includes plural pieces of program data. Each of the plural pieces of program data indicates the contents on one broadcasting program, and further includes a program information element, e.g., data on the time zone indicating a broadcasting time zone, and program attribution data indicating the attribution on the broadcasting program. The program attribution data includes the following program information elements (1) to (4):
(1) Channel identifier (e.g., channel No., channel name, or frequency) of a channel corresponding to the broadcasting program
(2) Program title data indicating a program title
(3) Program genre data indicating a program genre
(4) Specific information indicating specific contents of a program
   That is, one piece of program data includes at least one type of program information elements from among plural types of program information elements, corresponding to one broadcasting program. Referring to FIG. 1, a program guide area 194, which will be described later, of a display screen 192 of the display unit 190 displays: data on time zone corresponding to a display target channel 1 (data on time zone indicating that after the current time 11:45); and a program title indicated by the program title data corresponding to the display target channel 1. The program information elements included in the program information 171 may be extracted from the broadcasting signal received via the broadcasting-signal antenna 110 or inputted to the television apparatus 100 via a communication network (e.g., Internet) or a portable storage medium (e.g., a card memory).

The storage area 160 of information on the display condition is arranged to the same storage medium (e.g., memory) having the storage area 170 of program information, or another storage device. The storage area 160 of information on the display condition stores the information 161 on the display condition. The information 161 on the display condition includes at least one piece of the data on the display condition. Each of the plural pieces of data on the display condition indicates the display condition inputted from the operating unit 191. The data on the display condition may be inputted to the television apparatus 100 via a communication network (e.g., Internet) or a portable storage medium (e.g., a card memory), or may be inputted from the operating unit 191. The display condition for input includes the following display conditions (A) to (K).
(A) Display system (e.g., one of scroll display operation and intermittent switching display operation)
(B) Corresponding channel (e.g., one of all channels, a specific channel designated in advance by a user, and a channel selected as a display target)
(C) Broadcasting medium (e.g., one of BS, CS, terrestrial digital broadcasting, and terrestrial analog broadcasting)
(D) Time range indicating the display target of the program information element corresponds to the time zone from the current time (or end of the current time zone including the current time) to which time zone (e.g., selectable by the unit of hour, unit of days, or unit of week)
(E) Type of program information elements as a display target (e.g., at least one of time zone, program title, program genre, and program contents (that is, specific information))
(F) Display position indicating where in the display screen the program information element is displayed (e.g., bottom end, left bottom corner, left end, left top corner, top end, right top corner, right end, or right bottom corner)
(G) Display range (e.g., the display size is lateral width of the display screen and the longitudinal size is 2 cm)
(H) Character size upon displaying the program information element (e.g., one of large, middle, and small)
(I) Which is preferential of a broadcasting program video image and the program information element)?
(J) Whether or not the display position may be automatically switched in accordance with the program attribution
(K) On which video display secondary screen is program information element of which video display secondary screen displayed among plural video display secondary screens? (e.g., primary screen for audio output and a secondary screen on which the audio data is not outputted).
   At least one of the display conditions (A) to (K) is used. At least one of the plural display conditions may be freely set within a range of a predetermined set value by a user. Or, at least one of plural prepared options may be selected by the user. Or, the plural pieces of data on the display condition may include prepared data on the display condition, that is, data which cannot be set and changed by the user.

The display control unit 180 controls the processing for displaying the video image on the display unit 190. The display control unit 180 includes: a tuner which receives the broadcasting signal from the broadcasting-signal antenna 110 and selects a signal of the user desired channel; a demultiplexer which receives the signal outputted from the tuner and outputs the signal through specific signal processing; a decoder which decodes the signal (e.g., video/audio signal compressed by the MPEG2 format) outputted from the demultiplexer; and a CPU which controls the operation of the tuner or demultiplexer. The display control unit 180 executes at least one of the following processing (1) to (6).
(1) Processing in which a signal corresponding to a recording target channel designated by the operating unit 191 (channel selected as a recording target) is selected from a multiplexing signal (e.g., signal in a transport stream format) received via the broadcasting-signal antenna 110, and the selected signal or the signal converted into that in another format (e.g., signal in a program stream format) is stored in the storage device 140.
(2) Processing in which a signal corresponding to a display target channel (channel selected as a display target) designated by the operating unit 191 is selected from a multiplexing signal received via the broadcasting-signal antenna 110, and a video image indicated by the selected signal is displayed on the display unit 190.
(3) Processing in addition to the processing (2), in which the current time and the display target channel are detected, the current time zone (including the detected current time) and the time zone after that (hereinafter, referred to as “after-time zone) are determined from the program information 171 stored in the storage area 170 of program information based on the detected current time and display target channel, the program information element on the determined after-time zone is extracted, and the extracted program information element is displayed together with the video image.
(4) Processing in which, in the processing (3), the program information element on the after-time zone upon obtaining the program information element, that is, the program information element for satisfying the display condition indicated by the data on the display condition in the information 161 on the display condition is searched from the program information 171, and the searched program information element is extracted.
(5) Processing in which the program information element included in the multiplexing signal received via the broadcasting-signal antenna 110 is extracted, and the extracted program information element is written to the storage area 170 of program information, thereby updating the program information 171.
(6) Processing in which the display condition is received from the operating unit 191 and the received display condition is stored in the storage area 160 of information on the display condition, thereby updating the information 161 on the display condition.
   Specifically, in the processing (3), the display control unit 180 enables the display screen 192 of the display unit 190 to display the program video image 193 on the current time zone of the channel designated by the operating unit 191, the program guide area 194 overlapped to the grip forceps 193, and the program information element on the after-time zone, that is, the program information element extracted from the program information 171 in the program guide area 194. In this case, the display control unit 180 draws the program guide area 194 by a color with a transmission factor of 0 to 100% (e.g., 40 to 60%).

Hereinafter, a specific description is given of the processing of the display control unit 180.

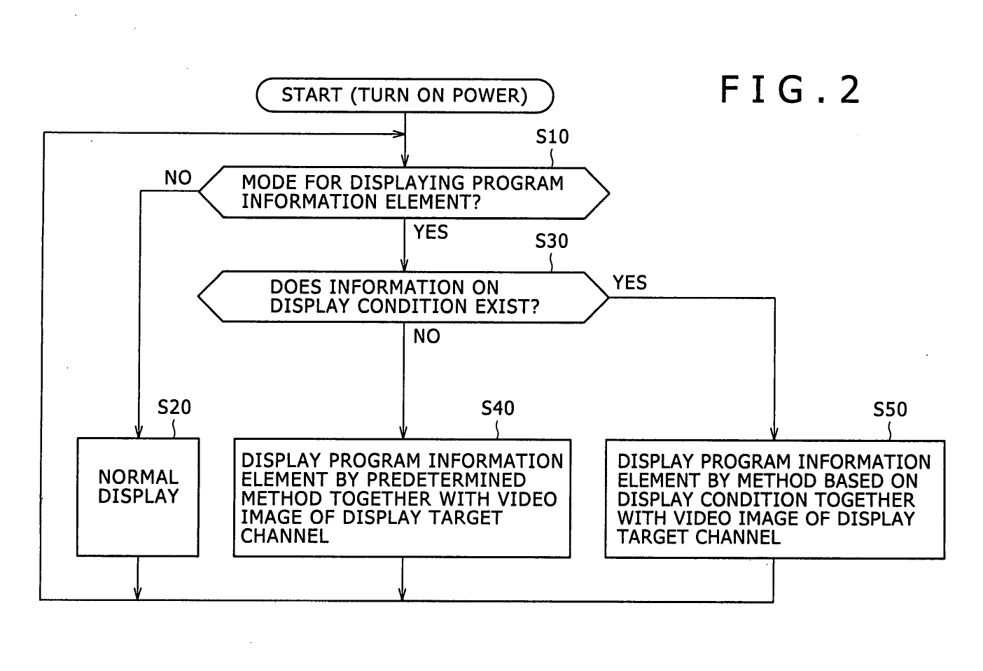

FIG. 2 is a flowchart of the processing of the display control unit 180 as one example.

The display control unit 180 determines whether or not a mode for displaying the program information element is executed after the start operation (e.g., after turning-on the power) (step S10). For example, when the operating unit 191 issues a command for executing the display mode of the program information element, the display control unit 180 sets a flag (hereinafter, display-mode executing flag) indicating the execution of the display mode to a memory (not shown). When the operating unit 191 issues a command for resetting the execution of display mode, the display control unit 180 resets the display-mode executing flag, thereby setting whether or not the display mode of the program information element is being executed. In step S10, the display control unit 180 executes the display mode by detecting whether or not the display-mode executing flag is set to the memory (or, the determination in step S10 may be executed by another method).

When it is determined in step S10 that the display mode of the program information element is not being executed (NO in step S10), the display control unit 180 performs processing of normal display operation, that is, processing for displaying the program video image corresponding to the selected channel as a display target and on the display unit 190 and processing for displaying the program information element (step S20).

When it is determined in step S10 that the display mode of the program information element is being executed (YES in step S10), the display control unit 180 determines whether or not the information 161 on the display condition is stored in the storage area 160 of information on the display condition (in step S30).

When it is determined in step S30 that the information 161 on the display condition is not stored (NO in step S30), the display control unit 180 displays the program information element by a predetermined method together with a program video image 193 corresponding to the channel selected as a display target (step S40). For example, the display control unit 180 displays the program guide area 194 overlaid to the program video image 193 of the display target channel in the entire bottom area of the display screen 192, and scroll-displays, in the program guide area 194, the program information element on the after-time zone of the display target channel. If the display target channel is switched to another channel, the display control unit 180 searches and extracts the program information element on the display target channel after the switching operation from the storage area 170 of program information. The extracted program information element may be scroll-displayed in the program guide area 194, or the display operation of the program information element may be reset.

When it is determined in step S30 that the information 161 on the display condition is stored (YES in step S30), the display control unit 180 displays, on the display unit 190, the program video image 193 corresponding to the selected channel, as a display target, and further displays the program information element by a method based on a display condition indicated by the data on the display condition in the information 161 on the display condition (S50). Hereinafter, a description is given of the processing in step S50 and the display operation on the display screen 192 as a result of the processing.

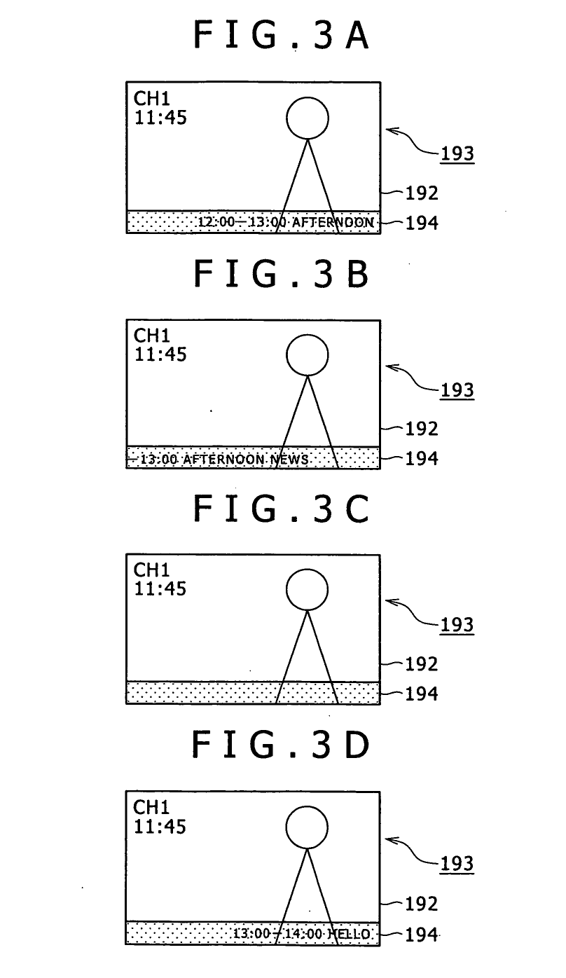

When the display control unit 180 detects the data on the display condition, to which the “scroll display” is set as a display condition, referring to FIGS. 3A to 3D, the program information element is scroll-displayed on the program guide area 194. In this case, referring to FIGS. 3A to 3C, the display control unit 180 completely ends the scroll-display operation of the program information element on one after-time zone (e.g., time zone or program title). Thereafter, referring to FIG. 3D, the scroll-display operation of the program information element on another after-time zone may start, or the program information element on one after-time zone and the program information element on another after-time zone may be continuously scroll-displayed.

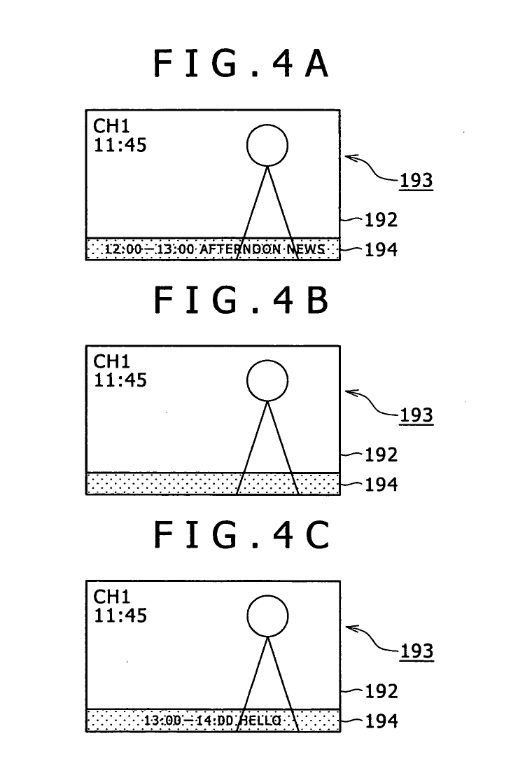

When the display control unit 180 detects the data on the display condition, to which the “intermittent switching display operation” is set as a display condition, referring to FIGS. 4A to 4C, the display operation of the program information element in the program guide area 194 is intermittently switched. That is, referring to FIG. 4A, the display control unit 180 extracts the program information element on one after-time zone, and continuously displays the program information element for a predetermined time. Then, referring to FIG. 4B, the display control unit 180 stops the display operation of the program information element. Referring to FIG. 4C, the program information element on one after-time zone is extracted and is then displayed. Incidentally, the user may change even the time zone for continuous display operation, as one display condition, by using the operating unit 191. When the display control unit 180 detects that the program information element is not displayed in the program guide area 194, the display control unit 180 may automatically the display format from the intermittent switching display operation to the scroll display operation.

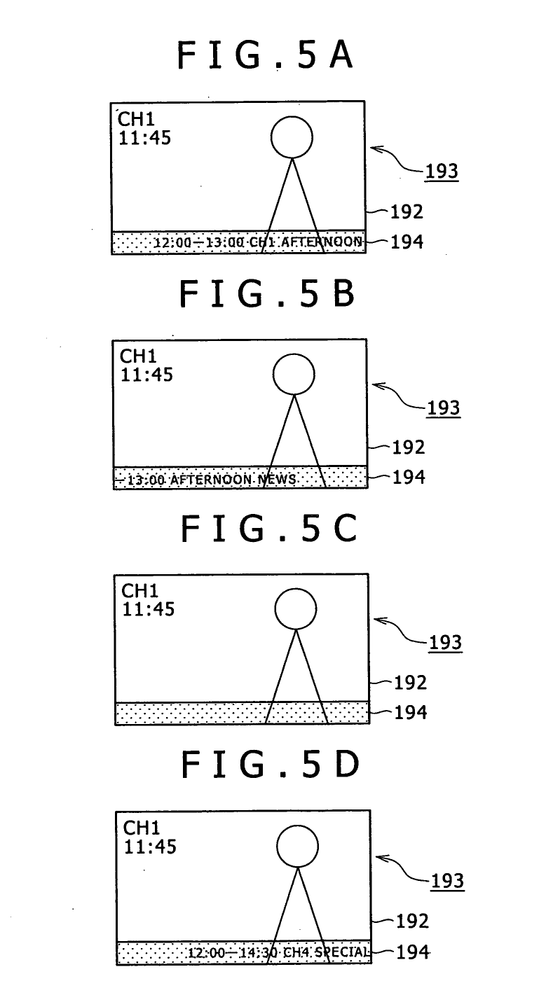

When the display control unit 180 detects that the data on the display condition which sets plural channels as display conditions, the display control unit 180 displays the program information elements on the after-time zones of the plural channels. FIGS. 5A to 5D show display examples of the program information elements on the plural channels. In the display examples, when displaying the program information element, the display control unit 180 displays not only the after-time zone and program title but also a channel No. so that the user understands the program information element on which channel. Further, the display control unit 180 may search for the program information element of the current time zone on another channel of the display target channel by using a channel identifier of the other channel, as a search key, from the program information 171, and then may display the searched program information element. Thus, the user knows which program is currently broadcasted on another channel while viewing the program video image corresponding to the display target channel.

When the display control unit 180 detects the data on the display condition, to which the “only the display target channel” is set, as a display condition, the display control unit 180 extracts and displays the program information element on the after-time zone of the display target channel. In this case, the display control unit 180 may not display the channel No. as the program information element.

When the display control unit 180 detects the data on the display condition to which a first broadcasting medium is set, the display control unit 180 displays the program information element on the after-time zone of the first broadcasting medium. For example, when the display control unit 180 displays the program video image on the first broadcasting medium, the display control unit 180 extracts and displays the program information element on the after-time zone on the first broadcasting medium. However, when the reception of first broadcasting medium is switched to that of a second broadcasting medium in accordance with a command from the operating unit 191, the display control unit 180 does not display the program information element. In this case, the program information 171 may be prepared for each broadcasting medium, or data on the broadcasting medium may be included, as the program information element, in the program information 171.

When the display control unit 180 detects the data on the display condition to which a time range is set, the display control unit 180 extracts and displays the program information element on the after-time zone within the time range. In this case, when the display control unit 180 ends to display the program information elements on all after-time zones within the time range, the display control unit 180 may start the processing again or may not display the program information elements until the current time zone shifts to the next one or until the display target channel is switched.

When the display control unit 180 detects that the data on the display condition to which the type of program information elements is set, the display control unit 180 selects and displays the program information element corresponding to the type of program information elements from among plural program information elements on one after-time zone.

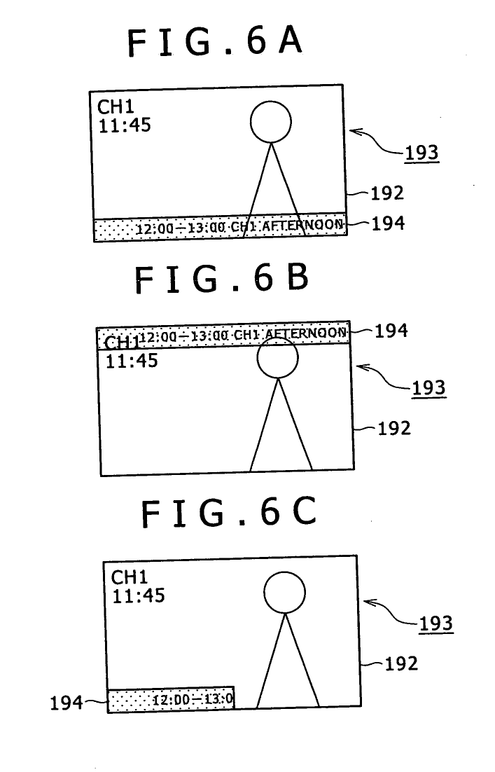

When the display control unit 180 detects the data on the display condition to which the display position is set, the display control unit 180 displays the program guide area 194 at the display position on the display screen 192. For example, when the set display-position is “bottom end”, referring to FIG. 6A, the display control unit 180 sets the program guide area 194 at the bottom end of the display screen 192. Further, when the set display-position is “top end”, referring to FIG. 6B, the display control unit 180 sets the program guide area 194 at the top end of the display screen 192. Furthermore, when the set display-position is “left bottom end”, referring to FIG. 6C, the display control unit 180 sets the program guide area 194 at the left bottom end of the display screen 192. Incidentally, at least one of the longitudinal size or the lateral size of the program guide area 194 is changed by “display range”, serving as a display condition, and may be fixed so as to prevent the change.

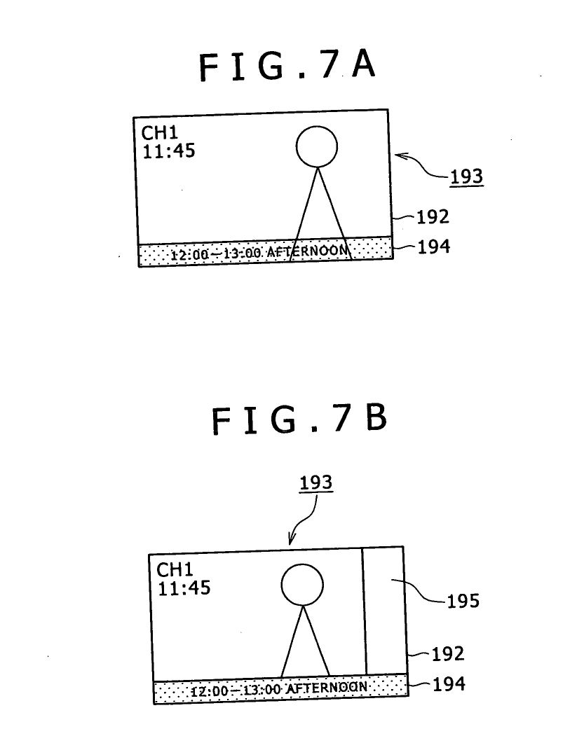

When the display control unit 180 detects the data on the display condition indicating that the broadcasting program video image is more preferential than the program information element, the display control unit 180 preferentially displays the program video image 193, rather than the program information element (for example, referring to FIG. 7A, the display range of the program video image 193 is not reduced and a translucent or completely transparent program guide area 194 is overlaid to the program video image 193). When the display control unit 180 detects the data on the display condition indicating that the program information element is more preferential than the broadcasting program video image, the display control unit 180 preferentially displays the program information element rather than the program video image 193 (for example, referring to FIG. 7B, the display range of the program video image 193 is reduced so as to prevent the overlay to the program guide area 194). In this case, when a free area 195 exists as shown in FIG. 7B, the free area 195 may display the program information element (e.g., detailed contents) corresponding to the program video image 193 in progress of display operation, or may display specific contents corresponding to the program information element in progress of display operation in the program guide area 194.

When the display control unit 180 detects the data on the display condition to which the display position of the program information element is automatically switched in accordance with the program attribution, the display position of the program guide area 194 is switched from the first position to the second position (e.g., from the top end to the bottom end, or from the bottom end to the top end) in accordance with the program (e.g., program genre) of the program video image 193 which is displayed. In place of the display condition (J) or in addition thereto, the display condition may include a display condition of at which display position is displayed the program information element in which program genre. In this case, the display control unit 180 grasps the program genre of the broadcasting program corresponding to the display target channel by a method for detecting the program genre data included in the broadcasting signal of the display target channel, and specifies the display position corresponding to the grasped program genre from the data on the display condition, thereby displaying the program information element on the after-time zone of the broadcasting program at the specified display position.

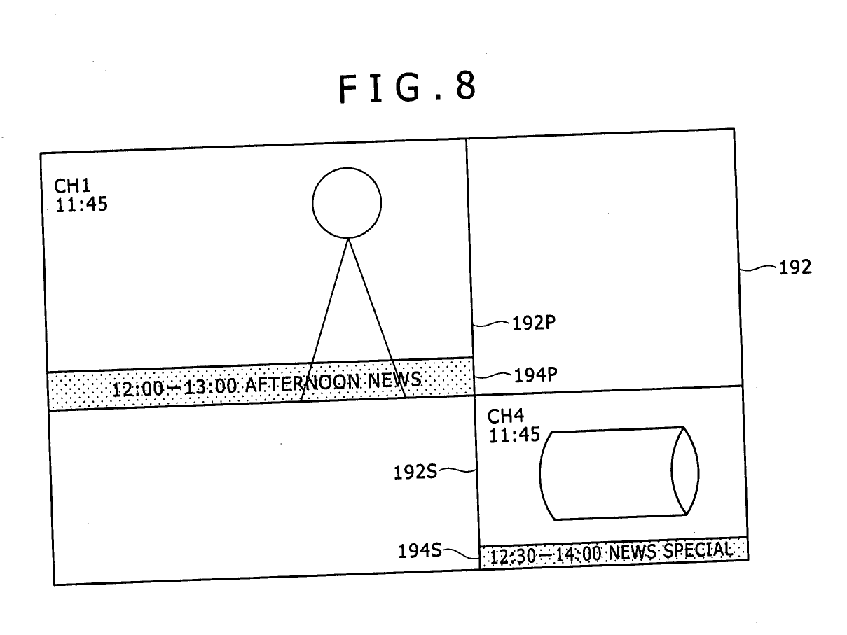

When the display control unit 180 displays, on the display screen 192, a primary screen 192P that is outputted as audio data and a secondary screen 192S that is not outputted as audio data, as plural secondary screens, as shown in FIG. 8, one of the primary screen 192P and the secondary screen 192S or both of them have program guide areas 194P and 194S. In this case, the display control unit 180 may individually control display methods of the program information elements on the primary screen 192P and the secondary screen 192S. Alternatively, the display control unit 180 may execute the same method as the display method on one screen (e.g., 192P) on the other screen (e.g., 192S). When the display condition is set to each of plural display secondary screens, the display control unit 180 may controls the display operation of program information elements under the display conditions on the display secondary screens. Although a description is given now, the plural display secondary screens individually display the display target channels. For example, when the channel 1 is set, as a display target channel of the primary screen 192P, referring to FIG. 8, the display control unit 180 displays the program video image of the channel 1 on the primary screen 192P. When a channel 4 is set, as a display target channel of the secondary screen 192S, the display control unit 180 displays the program video image on the secondary screen 192S.

According to the embodiment, it is possible to display the program information element on the time zone after the current time zone during which the program video image 193 is broadcasted together with the program video image 193. Thus, the user knows the broadcasting schedule while viewing the desired program video image 193.

According to the following modification of the embodiment, a user-friendly program recording schedule is executed.

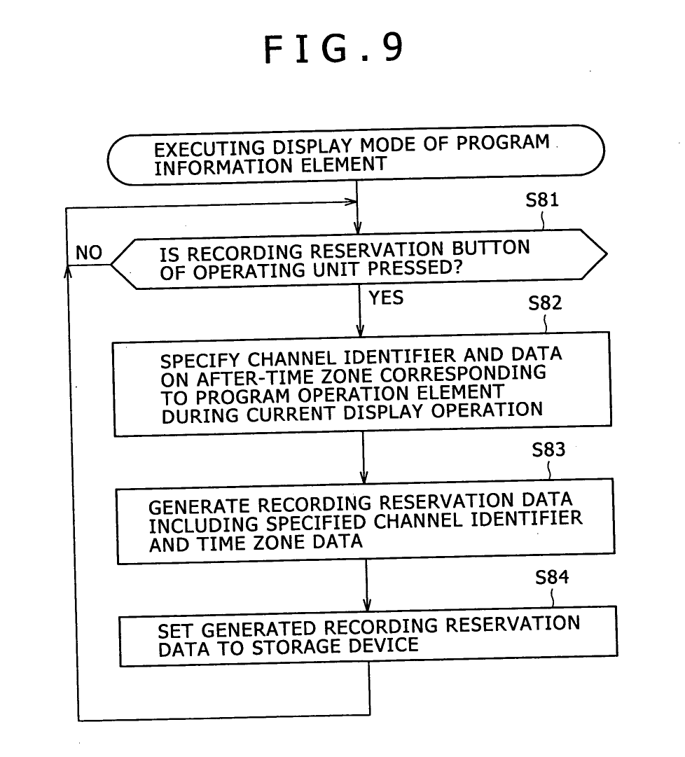

FIG. 9 is a flowchart showing an example of recording reservation processing of the display control unit 180 according to the modification of the embodiment of the present invention.

Although not shown, the operating unit (e.g., a remote controller) 191 has a recording reservation executing button. The user presses the recording reservation executing button during displaying the program information element on the desired after-time zone of the desired channel. When the recording reservation executing button is pressed, a signal corresponding thereto is given to the television apparatus 100 from the operating unit 191.

The display control unit 180 detects based on the signal from the operating unit 191 that the recording reservation executing button is pressed (YES in step S81), the display control unit 180 specifies the channel identifier and the data on the after-time zone corresponding to the program information element which is currently displayed (step S82). The display control unit 180 sets a flag for the program information element which is extracted and displayed in the storage area 170 of program information, thereby specifying which program information element of the plural ones is currently displayed.

Thereafter, the display control unit 180 generates the recording reservation data including the specified channel identifier and the after-time zone (step S83), and sets the recording reservation data to the storage device 140.

Through the above-mentioned flow, the reservation of recording in accordance with the program information element in progress of display operation ends. When the storage device 140 detects that the current time is the starting time of the after-time zone indicated by the data on the after-time zone in the recording reservation data, the storage device 140 starts to record the program of the channel specified from the channel identifier in the recording reservation data.

When the program guide area 194 displays the program information elements on plural after-time zones in the above-mentioned processing, the recording reservation data on the after-time zone which is first displayed among the plural after-time zones, or the recording reservation data which is finally displayed maybe generated. It maybe set, as one display condition, which after-time zone is used among the plural after-time zones. When the command for reserving the recording is received from the operating unit 191 while both the primary screen 192P and the secondary screen 192S display the program information element, the display control unit 180 generates the recording reservation data by using the program information element displayed on the main screen 192P, or may generate the recording reservation data by using the program information element displayed on the secondary screen 192S.

Although the embodiment and the modification according to the present invention are described, the range of the present invention is not limited to this. A well-known person can add, delete, or change the structure without departing from the range of the present invention. For example, the flowcharts shown in the drawings simply show the processing flow without departing from the understanding and embodiment of the present invention and therefore the well-known person easily can exchange, delete, or change the steps. The number of program guide areas 194 may be two or more (e.g., the program guide areas 194 may be arranged to the top end and the bottom end of the display screen 192). The program information elements having different contents may be displayed to the two ore more program guide areas 194. The degree of transparency in the program guide area 194 may be freely set by the user. In place of the after-time zone just after the current after-time zone, the period of broadcasting time may be displayed. When the number of display screens 192 is plural, one screen may display the broadcasting program video image and another screen may display the program information element. It may be dynamically switched in accordance with the user operation of the operating unit 191, whether or not the program information element is displayed or which program information element is displayed. The display control unit 180 may set so that the number of display times of the program data on the after-time zone just after the current time zone among the plural pieces of the program data corresponding to the plural after-time zones is larger than the number of pieces of program data on the after-time zone thereafter.

What is claimed is:

1. A program output control apparatus comprising:
a storage area of program information that stores program information; and
output controller that controls an output of a user-desired program corresponding to a broadcasting channel selected by a user and display operation of the program information from among a plurality of programs being broadcasted corresponding to a plurality of broadcasting channels,
wherein the program information includes two or more pieces of program data corresponding to two or more broadcasting programs, and the two or more pieces of program data include a broadcasting time zone of the broadcasting program corresponding to the program data and broadcasting program attribution indicating an attribution of the broadcasting program, and the output controller executes at least one of:
(1) processing for obtaining, from the storage area of program information, the program data on the broadcasting channel selected by the user from among the plurality of broadcasting channels and on a time zone after the current time zone of the broadcasting channel; and
(2) processing for obtaining, from the storage area of program information, the program data on another broadcasting channel of the broadcasting channel selected by the user from among the plurality of broadcasting channels, and on at least one time zone at or after the current broadcasting time zone of the other broadcasting channel, and
further executes display operation of the obtained program data together with the output of the user-desired program.

2. The program output control apparatus according to claim 1, wherein the program output control apparatus is communicable with a storage device that stores the broadcasting program, and
the output controller executes processing for receiving a recording command of the broadcasting program, specifying, in response to the recording command, the program data in progress of display operation from the two or more pieces of program data and for automatically processing for recording, to the storage device, the broadcasting program corresponding to the program data by using a broadcasting time zone and an attribution of the broadcasting program included in the specified program data, when the date and time are the broadcasting time zone.

3. The program output control apparatus according to claim 1, wherein the program output control apparatus further comprises a storage area of display condition that stores display condition data, to which a time range starting from a time point in the current time zone, is set as a display condition, and
the output controller specifies the program data corresponding to an after-time zone within the time range from the storage area of program information based on the time range set to the display condition data and the broadcasting time zone included in each of the two or more pieces of program data, and displays the specified program data.

4. The program output control apparatus according to claim 1, wherein the broadcasting program is a television broadcasting program including a program video image,
the program output control apparatus further comprises a display screen, and
the output controller displays, on the display screen, the program video image of the user-desired program, overlays and displays a program guide area to the program video image at an end of the display screen or near it, and displays the obtained program data in the program guide display area.

5. The program output control apparatus according to claim 4, wherein the output controller selectively switches between a first display system for fixing display operation of the program data in the program guide display area to the program guide display area and a second display system for scroll-displaying the program data in the program guide display area, in accordance with whether or not the display operation of the obtained program data is included in the program guide display area.

6. A program output control method comprising:
a step of outputting a user-desired program corresponding to a broadcasting channel selected by a user from among a plurality of programs being broadcasted corresponding to a plurality of broadcasting channels;
a step of executing at least one of
(1) processing for obtaining, from a storage area of program information, program data on the broadcasting channel selected by the user from among the plurality of broadcasting channels and on a time zone after the current time zone of the broadcasting channel, of two or more pieces of program data including broadcasting time zones and broadcasting program attributions of two or more broadcasting programs, and
(2) processing for obtaining, from among the two or more pieces of program data, the program data on another broadcasting channel of the broadcasting channel selected by the user from among the plurality of broadcasting channels and on at least one time zone at or after the current broadcasting time zone of the other broadcasting channel; and
a step of executing display operation of the obtained program data together with an output of the user-desired program.
